(19) United States
(12) Patent Application Publication
(10) Pub. No.: US 2007/0187178 A1
(43) Pub. Date: Aug. 16, 2007

(54) FLOATING LADDER SYSTEM

(76) Inventor: Jeffrey Tellex, Lantana, FL (US)

Correspondence Address: MCHALE & SLAVIN, P.A., 2855 PGA BLVD, PALM BEACH GARDENS, FL, 33410, US

(21) Appl. No.: 11/671,311

(22) Filed: Feb. 5, 2007

Related U.S. Application Data
(60) Provisional application No. 60/772,922, filed on Feb. 13, 2006.

(51) Int. Cl. E06C 9/00

(52) U.S. Cl. 182/84

(57) ABSTRACT

The purpose of this invention is to provide a floating ladder system for use on a platform. The floating ladder system includes a mounting section having a base for securely attaching to a platform and including two opposing tracks defining ladder leg receiving channels. The ladder system includes a generally vertical ladder having an upper and a lower portion, with a pair of opposed legs slidably disposed in receiving channels of the mounting section. The ladder system also includes at least one float connected to the lower portion of ladder. The float constructed and arranged to automatically translate from an at least partially submerged position for easy access to a free-floating position on top of the water.

### REFERENCE TO RELATED APPLICATION

This application claims benefit of provisional U.S. Application No. 60/772,922, filed Feb. 13, 2006, the contents of which are incorporated herein by reference in its entirety.

### FIELD OF THE INVENTION

This invention relates generally to a ladder, and more particularly, to a floating ladder that is mountable to a platform and floats to the water surface to decrease the rate of marine growth and/or corrosion on the ladder.

### BACKGROUND OF THE INVENTION

Dock ladders are known in the art and used to provide access between a platform (e.g., dock, pier, deck, seawall) and a boat or water. Most conventional dock ladders are stationary and fixed such that the bottom portion (lowermost rungs) remains continuously submerged in water so that a swimmer can safely and quickly get in and out of the water. However, these dock ladders quickly corrode, especially when submerged in the saltwater environment. In less than ten months, the submerged portions of a pristine ladder can become covered with marine growth, including, barnacles, oysters, and the like. Most of the aforementioned marine growth have shells with sharp edges, which increase the likelihood of injuring a user traversing the ladder. In addition, any metallic portions of the submerged ladder undergo electrolysis when submerged in the marine environments. This also causes corrosion and decreases the service life of the ladder.

While some ladders include mechanisms (cables, wires, etc) that cause the ladder to fold up and out of the water, they are typically left down. In addition, these complicated mechanisms make these ladders expensive and prone to breaking after repeated use (i.e., cable breakage, etc.) As a consequence of these aforementioned problems, it is an object of the present invention to provide a ladder that remains above the water when not in service, thereby extending the overall life of the ladder.

### DESCRIPTION OF THE PRIOR ART

The prior art discloses numerous moving ladders for use on platforms that provide user access to a marine vessel. For example, U.S. Pat. No. 4,067,412, to Jackson discloses a rigid guide assembly having two inwardly disposed channel members secured to the stringer of a stationary platform and one end of a support member attached at each outward side of the top portion of the channel member. The other end of each support member is secured to the decking of the stationary platform. A vertical ladder secured to a floating base is disposed between the flanges of the two channel members thereby restricting the lateral movement of the ladder and float while allowing vertical movement as the water changes.

The prior art devices have not satisfied the needs of users by providing safe access to a dock ladder when in the water. The floating base disclosed in the '412 patent has a buoyancy designed to prevent the ladder assembly from sinking when a person of normal weight steps onto the ladder. That is, the ladder system of '412 keeps both the ladder and the person out of the water at all times. Thus, an individual must traverse the ladder and the float when entering or leaving the water or boat. Access to the water is done by slipping off the float. There is no provision for mounting the float from the water. This design can be dangerous should the swimmer need to leave the water quickly or during a rescue situation. If a child attempts to use the ladder, the float will not allow the bottom step to sink making it very difficult to climb. Further, if an individual of above normal weight individual attempts to climb the ladder, the float will cause the ladder to act unpredictably. For instance, once the above normal weight individual gets off the ladder, it may violently project upward as the float surfaces.

The float of present inventive dock ladder system becomes submerged when a load is placed thereon. Once the load is removed, the ladder slides to the original position. Thus, the present inventive ladder system provides the safety and convenience of a fixed stationary ladder without the marine growth and corrosion, as explained in detail below.

### SUMMARY OF THE INVENTION

The instant invention is directed toward a ladder system

Accordingly, it is an objective of the instant invention to provide a ladder system designed to keep ladder rungs free from hazardous marine growth, thus significantly decreasing the possibility of user injury and reducing electrolysis and corrosion resulting in the increased service life of the ladder.

Still another objective of the present invention is to disclose a ladder system having a low profile to minimize interference with a nearby marine vessel.

Another objective of the present invention is to teach a floating ladder system designed for use with a stationary platform (e.g., dock, deck, pier, pool, etc) or floating platform (e.g., boat surface.)

The ladder 10 is safe and provides easy access to and from a platform (dock, deck, pier) at any water level.

Yet another objective of the present invention is to teach a ladder system that includes a locking means (plunger) that secures the ladder while in use or in a desired position.

Ladder steps 13 are grooved to help prevent slipping. The ladder float adjusts the ladder to any water level fluctuation and is made from high impact resistant plastic for longevity.

Still another objective of the invention is to provide a ladder float that is quick to submerge and slow to surface. The float preventing injury to individuals caught between the float and a dock during a rising tide or from a boat wake.

Yet another objective of the invention is to provide a floating ladder having a handgrip that runs parallel to the legs.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof. It will be readily appreciated by those skilled in the art that the use of a material-handling device for the purpose of transporting items thereon is useful in the art.

### BRIEF DESCRIPTION OF THE FIGURES

FIG. 1 is a front view of the floating ladder in accordance with one embodiment of the instant invention.

FIG. 2 is a side view of the floating ladder in accordance with one embodiment of the instant invention.

FIG. 3 is a cross-sectional view of the floating ladder in accordance with the instant invention.

FIG. 4 is a perspective view of the preferred embodiment of the floating ladder in accordance with the instant invention.

FIG. 5 is a side view of the preferred embodiment of the floating ladder in accordance with one embodiment of the instant invention.

### DETAILED DESCRIPTION OF THE INVENTION

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

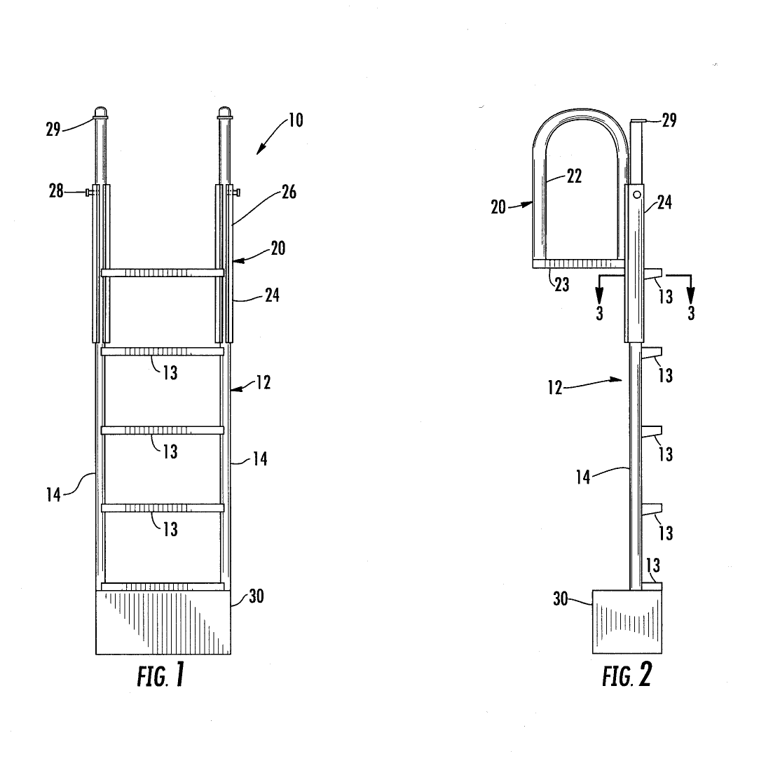

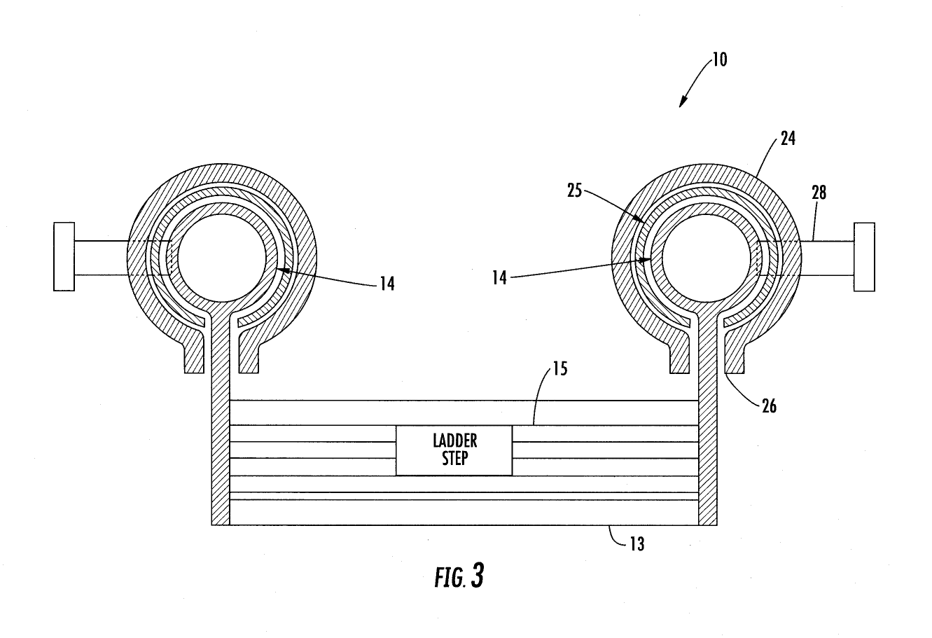

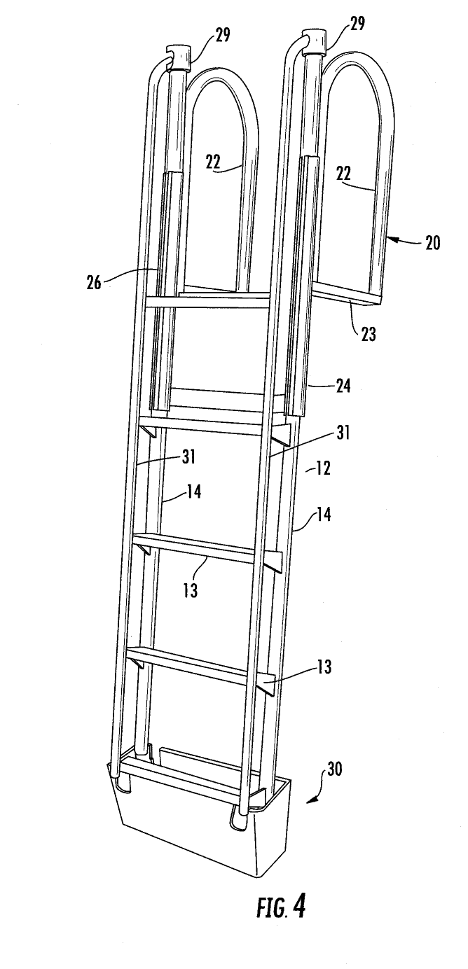

Referring now to FIGS. 1-6, wherein like elements are numbered consistently throughout, FIG. 1 illustrates one embodiment of the floating ladder system according to the present invention, generally referenced herein as 10.

The instant invention is a floating ladder system that provides access to and from the water or a vessel and floats near the surface of the water when not in use to keep the majority of the ladder out of the water. The floating ladder 10 also provides safe, easy access in and out of the water. According to one embodiment, the floating ladder can be locked in the floating position to prevent unauthorized use of the ladder.

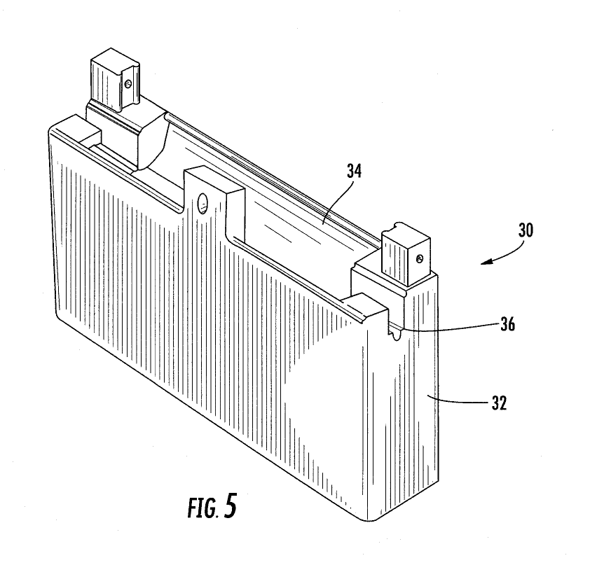

With reference to FIGS. 1-3, the floating ladder system 10 comprises an upper mounting section 20, a ladder 12 slidably coupled to the mounting section, and at least one float 30 connected to or near the bottom end of the ladder 12. The mounting section comprises a frame 22 having opposing arcuate sections for accessing the ladder, supporting the ladder and providing a handle when getting in and out of the water. The mounting section also includes a base 23 that is securely affixed to a platform (dock, deck, boat, pier) and a track system. The track system includes opposing tracks 24 defining ladder leg receiving channels 26. Referring now to FIG. 4, the floating ladder system may also include an additional rail which extends along the longitudinal length of the ladder providing additional assistance to the user as they traverse the ladder. As depicted here the addition rail is affixed to the top portion of the ladder and along each rung.

The ladder 12 comprises a pair of substantially parallel opposing legs 14 joined by a plurality of rungs 13 and at least one float 30 connected to or near the bottom end of the ladder 12. Preferably, the rungs comprise a plurality of grooves to reduce the chance of slippage. Each leg 12 is preferably round and slidably disposed in the channel 26 of the track 24 corresponding to the respective leg. The track system includes a bushing 25 made from a friction-reducing material (e.g., TEFLON, polypropylene, nylon, etc . . . ) and located between the leg and the interior surface of the track for guiding and facilitating smooth movement of the ladder up and down the track 24. The ladder 12 includes a stop plate 29 at or near the top of each leg 14 for preventing complete removal of the ladder from the tracks 24. The ladder system 10 is designed to be easily upgraded as needed, such as, wider steps and handrails. The stop plate further permits a controlled placement of the steps. For instance, in shallow water the ladder need not be deployed to an extent that would cause the ladder to touch the ground under the water.

The float 30 preferably comprises a plastic float attached to the underside of the lowermost step 13. The float 30 provides positive buoyancy for the ladder 12 causing the ladder to float above the water line to keep the ladder legs 14 and steps 13 free from marine growth. According to one embodiment, the float 30 is made from a high impact resistant polymeric material for longevity. The float includes an internal EPS foam to ensure positive buoyancy. According to a preferred embodiment, the float is made from Low Density Polyethylene that provides an exceptionally smooth surface that precludes marine growth from attaching. The ladder float 30 is attached to the ladder 12 at a selected lower step and, or each leg 14 with thru-bolts (e.g., stainless steel). The ladder float 30 keeps steps 13 free from hazardous marine growth.

In addition, the ladder system 10 components are constructed from an inert material including, albeit not limited to, marine grade aluminum (6000 series), steel, polymeric material or combination thereof. The floating ladder system 10 is preferably fabricated using all-welded construction for maximum strength. All ladder components are designed for low maintenance. The track system 24, 26 allows the ladder 12 to adjust to water level changes. The ladder 10 is safe and provides easy access to and from a platform at any water level. The ladder 10 has a low profile to minimize interference with vessels. The floating ladder 10 is designed for use with any dock, deck, pier, pool or boat surface. Ladder steps 13 are grooved to help prevent slipping.

According to one embodiment, the ladder 12 is secured in a selected vertical position by a locking means 28, shown here as a plunger laterally extending through each track 24. The locking plunger 28 may be spring-biased or manually actuated and may pinch the ladder leg 14 or engage a detent or aperture (not shown). There may be a plurality of detents or apertures for multiple settings. For example, when the ladder 12 is deployed by an individual such that it is carrying a load, the ladder slides down the track 24 toward the water and locks automatically in the down position when the spring-loaded plunger 28 engages the detent or aperture. In the down and locked position the lower portion of the ladder is submerged allowing for a convenient first step up the ladder for easy access and use. Although it depends on installation on the platform, the ladder should have at least two rungs in the water. Once the load is removed from the ladder 12 and the locking pin/plunger 28 manually retracted, the ladder 12 returns to a “free floating” position where the float resides on top of the water.

A handgrip 31 is placed parallel to the legs 14 extending from the float 30 to the stop plate 29. The hand grip may operate as an outward support to each rung as well as a smooth handhold to allow an individual too transverse the ladder using the rungs only as steps. In this manner, the rungs may include a roughed surface which is beneficial to prevent foot slippage, but otherwise may be rough on the hands of an individual. The amount of rungs is dependent on the distance from the water surface to the platform. Four rungs through eight rungs is contemplated for meeting most installations.

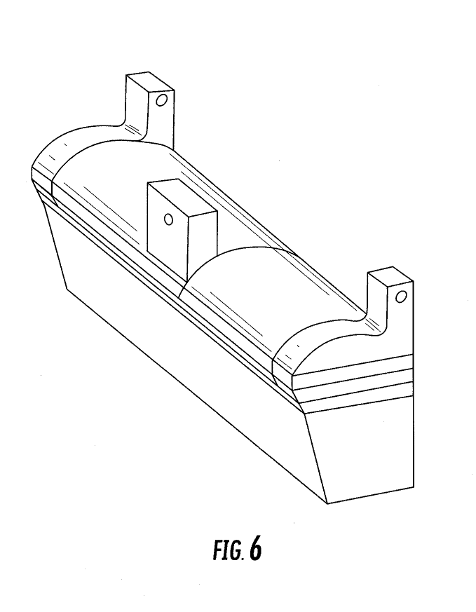

According to another embodiment shown in FIGS. 5 and 6, the float includes a water-tight float chamber 32 designed to ensure positive buoyancy. As discussed above, this may include air and/or internal EPS foam. The float also includes a ballast chamber 34 with ports or channels 36 therein and designed to flood with water when submerged. The ballast chamber volume and float chamber volume are selected to submerge the float in response to flooding the ballast chamber, yet the positive buoyancy of the float chamber will counteract the ballast weight causing the float to ascend toward the surface of the water, as discussed further below. In one embodiment, the top of the float can be configured to trap water when submerged. As the float rises, the trapped water can be drained so at to slow the conversion from a submerged deployed position to a raised storage position.

As with the previous embodiment, when an individual gets onto the ladder 12 it slides down the track 24 until the stop plate on the latter meets the top of track. Consequently, the lowermost steps 13 and float are submerged allowing for a convenient first step up the ladder for easy access and use. The ports or channels of the float chamber will cause water to flood the ballast chamber as it submerges. Once the load is removed from the ladder 12, the float is weighed down by the ballast chamber therein. However, the float is constructed such that the positive buoyancy of the float chamber will counteract the weight of the filled ballast chamber and cause the float and ladder to ascend along the track. Once the port or channels of the float are above the surface of the water, the water inside the ballast chamber of the float will drain out or purge through the ports or channels, thereby slowly the returning of the ladder to its original “free floating” position. In this manner, the ladder is not submerged yet a person in the water will be able to easily pull down on the float at anytime and access the lowermost rungs.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A floating ladder system, comprising:
a mounting section having a base for securely attaching to a platform and including two opposing tracks defining ladder leg receiving channels;
a generally vertical ladder having an upper and a lower portion, said ladder having a pair of opposed legs slidably disposed in said receiving channels and constructed and arranged to prevent lateral movement of said legs;
at least one float connected to said lower portion of said ladder, said at least one float constructed and arranged to automatically translate from a deployed submerged position for easy access to a storage free-floating position.

2. The floating ladder system of claim 1, wherein said channel includes a bushing having a friction-reducing material for guiding and facilitating smooth movement of said ladder along said track.

3. The floating ladder system of claim 2, wherein said bushing is formed of a non-metallic material.

4. The floating ladder system of claim 1, wherein said leg is tubular shaped.

5. The floating ladder system of claim 1, wherein said at least one float has ballast chamber volume and float chamber volume constructed and arranged to automatically translate from an at least partially submerged position to a storage free-floating position.

6. The floating ladder system of claim 1 including a locking plunger to secure said legs in a fixed position.

7. The floating ladder system of claim 1 including a handgrip placed parallel to each said leg.

8. The floating ladder system of claim 1 including a stop plate secured to an upper end of each leg, said stop plate positioning said legs in a predetermined location when said ladder is deployed.

9. A floating ladder system comprising:
a mounting section having a base for securely attaching to a platform and including two opposing tracks defining ladder leg receiving channels;
a generally vertical ladder having an upper and a lower portion, said ladder having a pair of opposed legs slidably disposed in said receiving channels and constructed and arranged to prevent lateral movement of said legs;
a friction-reducing bushing placed within said track for guiding and facilitating smooth movement of said ladder along said track;
a handgrip mounted parallel to each said leg;
a stop plate secured to an upper end of each leg, said stop plate positioning said legs in a predetermined location when said ladder is deployed;
at least one float connected to said lower portion of said ladder, said at least one float constructed and arranged to automatically translate from an a deployed submerged position for easy access to a storage free-floating position.

10. The floating ladder system of claim 9, wherein said at least one float has ballast chamber volume and float chamber volume constructed and arranged to automatically translate from a submerged position to a storage free-floating position.
